(19) United States
(12) Patent Application Publication
(10) Pub. No.: US 2026/0012906 A1
(43) Pub. Date: Jan. 8, 2026

(54) IDENTIFIER DETERMINATION OF SUBNETWORK

(71) Applicant: Nokia Technologies Oy, Espoo (FI)

(72) Inventors: Dong LI, Shanghai (CN); Tao TAO, Shanghai (CN); Saeed Reza KHOSRAVIRAD, Mountainside, NJ (US); Paolo BARACCA, Stuttgart (DE)

(21) Appl. No.: 18/992,621

(22) PCT Filed: Jul. 14, 2022
(86) PCT No.: PCT/CN2022/105781

§ 371 Date: Jan. 9, 2025

(51) Int. Cl. H04W 56/00; H04L 5/00; H04L 25/02; H04L 27/26

(52) U.S. Cl. CPC H04W 56/0015; H04L 5/0051; H04L 25/0204; H04L 27/2605

(57) ABSTRACT

Example embodiments of the present disclosure relate to devices, methods, apparatuses and computer readable storage media for identifier determination of a subnetwork. In example embodiments, a first network device in a subnetwork of a radio access network obtains a first identifier and a second identifier of the subnetwork. Then, the first network device transmits, to one or more terminal devices in the subnetwork, a synchronization signal, wherein the synchronization signal is based on the first identifier. Further, the first network device uses the second identifier in data communication, within the subnetwork, with at least one of the one or more terminal devices.

### FIELD

Example embodiments of the present disclosure generally relate to the field of communication, and in particular, to methods, apparatuses and computer readable storage media for identifier determination of a subnetwork.

### BACKGROUND

From 5th generation (5G) networks to 6th generation (6G) networks, the number of devices increases significantly. In many scenarios, devices will evolve to be a network of devices, also referred to as a subnetwork. The subnetwork is a promising component of 6G networks to meet the extreme performance requirements in terms of latency, reliability and/or throughput envisioned for certain 6G short-range scenarios. The subnetworks are generally installed in specific entities, for example, in-vehicle, in-body, in-house, to provide life-critical data services with extreme performances over the local capillary coverage.

### SUMMARY

In general, example embodiments of the present disclosure provide devices, methods, apparatuses and computer readable storage media for identifier determination of the subnetwork.

In a first aspect, a first network device in a subnetwork of a radio access network is provided which comprises at least one processor and at least one memory including computer program code. The at least one memory and the computer program code are configured to, with the at least one processor, cause the first network device to obtain a first identifier and a second identifier of the subnetwork. The first network device is further caused to transmit, to one or more terminal devices in the subnetwork, a synchronization signal, wherein the synchronization signal is based on the first identifier. Then, the first network device is further caused to use the second identifier in data communication, within the subnetwork, with at least one of the one or more terminal devices.

In a second aspect, a terminal device in a subnetwork of a radio access network is provided which comprises at least one processor and at least one memory including computer program code. The at least one memory and the computer program code are configured to, with the at least one processor, cause the terminal device to receive, from a first network device in the subnetwork, a synchronization signal, wherein the synchronization signal is based on a first identifier of the subnetwork. Then, the terminal device is caused to use a second identifier of the subnetwork in data communication with the first network device and/or with at least one of one or more terminal devices in the subnetwork.

In a third aspect, a second network device in a radio access network is provided which comprises at least one processor and at least one memory including computer program code. The at least one memory and the computer program code are configured to, with the at least one processor, cause the second network device to transmit, to a first network device in a subnetwork of the radio access network, configuration information indicative of at least one of the following: at least one first identifier of the subnetwork, and at least one second identifier of the subnetwork.

In a fourth aspect, a method is provided. In the method, a first network device in a subnetwork of a radio access network obtains a first identifier and a second identifier of the subnetwork. Then, the first network device transmits, to one or more terminal devices in the subnetwork, a synchronization signal, wherein the synchronization signal is based on the first identifier. Further, the first network device uses the second identifier in data communication, within the subnetwork, with at least one of the one or more terminal devices.

In a fifth aspect, a method is provided. In the method, a terminal device in a subnetwork of a radio access network receives, from a first network device in the subnetwork, a synchronization signal, wherein the synchronization signal is based on a first identifier of the subnetwork. Then, the terminal device uses a second identifier of the subnetwork in data communication with the first network device and/or with at least one of one or more terminal devices in the subnetwork.

In a sixth aspect, a method is provided. In the method, a second network device in a radio access network transmits, to a first network device in a subnetwork of the radio access network, configuration information indicative of at least one of the following: at least one first identifier of the subnetwork, and at least one second identifier of the subnetwork.

In a seventh aspect, there is provided an apparatus comprising means for performing the method according to the fourth aspect, the fifth aspect or the sixth aspect.

In an eighth aspect, there is provided a computer readable storage medium comprising program instructions stored thereon. The instructions, when executed by a processor of a device, cause the device to perform the method according to the fourth aspect, the fifth aspect or the sixth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIGS. 1A-1D show several typical subnetwork use cases according to some example embodiments of the present disclosure;

FIG. 2 shows a simplified block diagram of an environment in which embodiments of the present disclosure may be implemented;

FIG. 3 shows a signaling flow between devices according to some example embodiments of the present disclosure;

FIG. 4 shows an example process with the proposed dual-identifier framework for a subnetwork in overlay network coverage according to some example embodiments of the present disclosure;

FIG. 5 shows another example process with the proposed dual-identifier framework for a subnetwork out of overlay network coverage according to some other example embodiments of the present disclosure;

FIG. 6 shows a flowchart of an example method for the first network device according to some example embodiments of the present disclosure;

FIG. 7 shows a flowchart of an example method for the terminal device according to some example embodiments of the present disclosure;

FIG. 8 shows a flowchart of an example method for the second network device according to some example embodiments of the present disclosure; and

FIG. 9 shows a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services may be provided to a subnetwork in a communication network. As an example, the network device may comprise a base station. The base station may comprise any suitable device via which a subnetwork may access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like. For the purpose of discussion, some example embodiments will be described with reference to base station as an example of the device.

As used herein, the term “subnetwork” refers to a network of devices composed of a plurality of devices capable of wireless communication with each other therein. The communication in the subnetwork may involve transmitting and/or receiving wireless signals using electromagnetic signals, radio waves, infrared signals, and/or other types of signals suitable for conveying information over air. In some example embodiments, the subnetwork may be configured to transmit and/or receive information without direct human interaction. For example, the subnetwork may include a robot, an autonomous vehicle, a home appliance, a wearable device or any other devices that are capable of communication. The plurality of devices in a subnetwork may be physically separated entities or may be integrated into one or more physical entities. As an example, the subnetwork may comprise a network device and several terminal devices communicating with each other.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

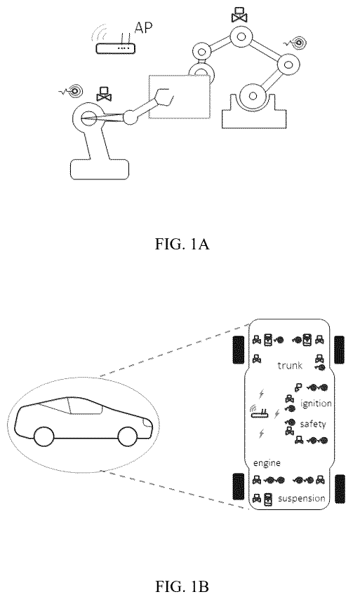

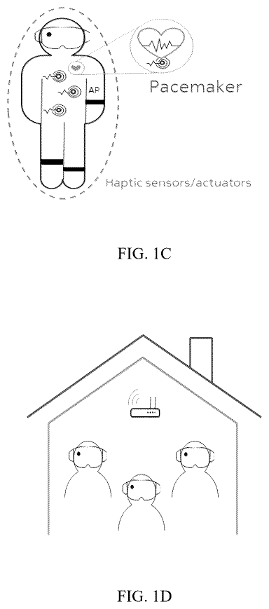

As stated above, from 5G networks to 6G networks, the number of devices increases significantly. In many scenarios, devices will evolve to be a network of devices, also referred to as a subnetwork. The subnetwork is a promising component of 6G system to meet the extreme performance requirements in terms of latency, reliability and/or throughput envisioned for certain 6G short-range scenarios. The subnetworks are generally installed in specific entities, for example, in-vehicle, in-body, in-house, to provide life-critical data service with extreme performances over the local capillary coverage. FIGS. 1A-1D show several typical subnetwork use cases according to some example embodiments of the present disclosure, where FIG. 1A shows an in-robot or in-production module subnetwork, and FIG. 1B shows an in-vehicle subnetwork, and FIG. 1C shows an in-body subnetwork, and FIG. 1D shows an in-house subnetwork.

The subnetworks have the following pivotal properties and technical features:
Support of extreme performance requirements in terms of latency, reliability and/or throughputs;
Low transmit power, which implies limited coverage range, for example in several meters;
Star or tree topology with at least one AP and one or more UEs under AP's control;
Overall mobility of AP and associated UEs, but lack/limited mobility across different subnetworks;
Part of overlay Wide Area Network (WAN) network, but must continue to work also when out of network coverage.

Each subnetwork shall have its own physical layer identifier (ID) which is used to differentiate from other subnetworks in terms of synchronization signals, reference signals, scrambling sequences and so on, for example, for interference suppression or randomization.

As subnetworks are mobile and high density is expected in some certain scenarios, for example, a jammed road for an in-vehicle scenario or a crowded event for an in-body scenario, one technical challenge of subnetwork ID allocation is the potential ID collision issue happening when two subnetworks far apart reusing the same ID move next to each other. That leads to ID collision and represents a threat to the provisioning of the extreme performances. Thus, the mobility of the subnetworks motivates more dynamic management and allocation of the subnetwork ID, rather than being configured in a static or quasi-static manner.

On the other hand, the computational complexity of the devices in the subnetwork must be kept as small as possible to adapt to the properties of small sizes and low-power capacity of these devices in the subnetworks deployments (although that can be dependent on the specific subnetwork scenarios, with very tight power constraints for the in-body and more relaxed ones for in-vehicle or in-robot). Therefore, more dynamic physical subnetwork ID allocation can provide benefits in terms of interference suppression, but, if not properly designed, may increase the complexity and power consumption of the devices in the subnetwork, for example, in searching for a synchronization signal from the AP in the subnetwork, which is not desired.

In order to solve at least part of the above problems and other potential problems, embodiments of the present disclosure provide a scheme for identifier determination of the subnetwork. With the scheme, a first network device in a subnetwork of a radio access network obtains a first identifier and a second identifier of the subnetwork. Then, the first network device transmits, to one or more terminal devices in the subnetwork, a synchronization signal, where the synchronization signal is based on the first identifier. Further, the first network device uses the second identifier in data communication, within the subnetwork, with at least one of the one or more terminal devices.

This scheme simultaneously supports flexible and dynamic identifier configuration and low complexity operations for devices in the subnetwork in initial access to the associated subnetwork. Thus, the proposed scheme may achieve efficient communication in the subnetwork.

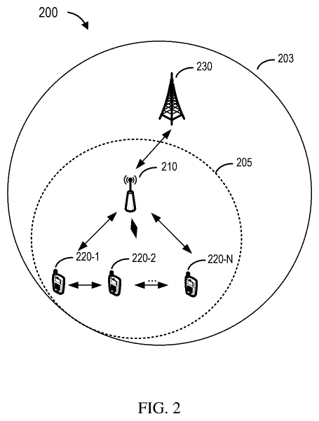

FIG. 2 shows an example environment 200 in which example embodiments of the present disclosure can be implemented. The environment 200, which may be a part of a communication network, comprises a radio access network 203. In the radio access network 203, a subnetwork 205 is comprised. The subnetwork 205 comprises a network device (also referred to as a first network device) 210 and a plurality of terminal devices 220-1, 220-2, . . . , 220-N where N represents any suitable positive integer. For the purpose of discussion, the terminal devices 220-1, 220-2, . . . , 220-N will be collectively or individually referred to as a terminal device 220. The radio access network 203 further comprises another network device (also referred to as a second network device) 230. In the environment 200, there is communications between the first network device 210 and the terminal device 220, and between the plurality of terminal devices 220-1, 220-2, . . . , 220-N, and between the first device 210 and the second devices 230.

As an example, the first network device 210 may be implemented as an AP, and the terminal device 220 may be implemented as a UE and the second network device 230 may be implemented by a base station (BS). In this case, the first network device 210, on the one hand, may serve and manage the plurality of terminal devices 220-1, 220-2, . . . , 220-N in the capillary subnetwork coverage. On the other hand, the first network device 210 may be connected to the second device 230, which may make a certain extent control and coordinate different subnetworks including the subnetwork 205.

It is also to be understood that the number of devices in the subnetwork 205 or in the environment 200 are shown in FIG. 2 only for the purpose of illustration, without suggesting any limitation to the scope of the present disclosure. There may be any suitable number of devices in the subnetwork 205 or in the environment 200.

The communication in the environment 200 may follow any suitable communication standards or protocols, which are already in existence or to be developed in the future, such as Universal Mobile Telecommunication System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and NR-U technologies.

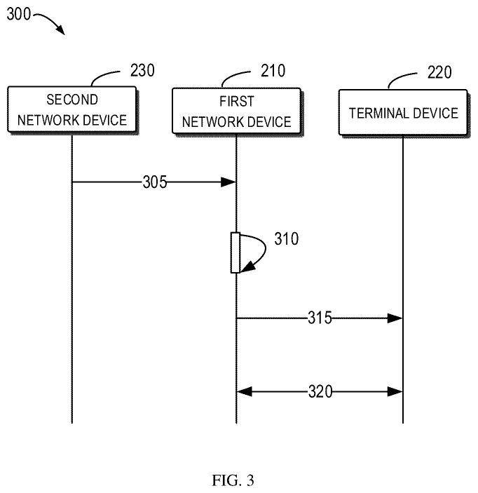

Detailed processes for the communications between devices will be discussed in the following with reference to FIGS. 3-5.

Reference is first made to FIG. 3 which shows a signaling flow 300 between devices according to some example embodiments of the present disclosure. For the purpose of discussion, the signaling flow 300 will be described with reference to FIG. 2. In some example embodiments, the first network device 210 may be implemented as an AP, and the terminal device 220 may be implemented as a UE, and the second network device 230 may be implemented by a BS.

In some example embodiments, the first network device 210 may access to the second network device 230 on behalf of the whole subnetwork to perform some necessary operations, for example, an establishment of RRC connections with the second network device 230, registrations and authentications to a core network, and so on.

Then, the second network device 230 may make configurations of resource/parameter setting to the first network device 210 to support the subnetwork operations. For example, as shown in FIG. 3, the second network device 230 may transmit (305), configuration information to the first network device 210.

For example, the configuration information may comprise information associated with identifier determination of the subnetwork 205. As an example, the subnetwork may have a first identifier and a second identifier. For example, the first identifier may have a small length, for example, 4 bits, corresponding to 16 candidate values for the first identifier which may form a set of candidate first identifiers. For example, the second identifier may have a relatively large bit size, for example, 10 bits, corresponding to at most 1024 candidate values for the second identifier which may form a set of candidate second identifiers.

As an example, the configuration information may indicate at least one first identifier of the subnetwork 205. Alternatively or in addition, the configuration information may indicate at least one second identifier of the subnetwork 205. The configuration information may then be used by the first network device 210 to determine the first identifier and/or the second identifier of the subnetwork 205.

Then, the first device 110 obtains (310) the first identifier and the second identifier of the subnetwork 205.

For example, the first device 110 may determine the first identifier in a variety of ways.

In some example embodiments, the first device 210 may determine the first identifier based on a set of first identifiers. In this case, for example, the first device 210 may randomly selects one from the set of first identifiers. As an example, if the first identifier has a bit size of 4 bits, the full set of first identifiers may consist of all candidate values of the first identifier. For example, the full set may be represented as {0,1,2,3, . . . 15}. Alternatively, the set of first identifiers may consist of a subset of the full set.

In some example embodiments, the first network device 210 may sense and monitor the potential first identifiers being used by other proximate subnetworks and selects a first identifier from the set of first identifiers that is not being used by other proximate subnetworks.

In some example embodiments, the configuration information may indicate at least one first identifier allocated by the second network device 230. In this case, if only one first identifier is configured, the first network device 210 may determine the first identifier as the allocated first identifier. If a set of first identifiers are configured, the first network device 210 may determine the first identifier from the configured set of first identifiers. As an example, the allocation of the first identifier may be made by the second network device 230 based on AP position information if available.

In some example embodiments, the first identifier may be obtained based on a preconfigured value. For example, the first identifier may be pre-configured by an operator/owner of the subnetwork and thus known to both the first network device 210 and terminal device 220. In this case, it will facilitate initial searching for the synchronization signal by the terminal device 220.

For example, the first device 110 may determine the second identifier in a variety of ways.

In the example embodiments where the configuration information indicates a second identifier of the subnetwork 205, the first device 210 may determine the second identifier as the indicated second identifier.

In the example embodiments where the configuration information indicates a set of second identifiers of the subnetwork 205, the first device 210 may determine the second identifier at least based on the configuration information. For example, the first device 210 may determine the second identifier from the indicated set of second identifiers. As an example, the first device 210 may perform channel sensing and then determine the second identifier from the indicated set of second identifiers by excluding one or more second identifiers being used by other proximate subnetworks. As another example, the first device 210 may randomly select one from the indicated set of second identifiers.

In some example embodiments, if the first network device 210 is out of overlay network coverage, the second identifier may be autonomously selected by the first network device 210 from a set of second identifiers. For example, the set may be a full set of the second identifiers or a subset of the full set. As an example, the first network device 210 may perform the channel sensing before the subnetwork transmissions and operations. Then, the first network device 210 may determine the second identifier by avoiding the second identifiers that are being used by the proximate subnetworks.

In is to be understood that the determination of the first identifier or the second identifier may be implemented in any other suitable ways, without suggesting any limitation as to the scope of the disclosure.

In some example embodiments, after the determination of the first identifier, the first network device 210 may generate a synchronization signal. For example, the first network device 210 may generate the synchronization signal at least based on the first identifier. Then, as shown in FIG. 3, the first network device transmits (315) the synchronization signal to one or more of the plurality of terminal devices 220-1, 220-2, . . . , 220-N in the subnetwork 205.

Further, in some example embodiments, based on the determination of the second identifier, the first network device 210 may further transmit, to the one or more of the plurality of terminal devices 220-1, 220-2, . . . , 220-N, a message indicative of the second identifier. As an example, the message may be transmitted via a synchronization channel which may also be called a physical broadcast channel in the subnetwork 205 with a reference signal associated with the synchronization channel. For example, the reference signal may be a demodulation reference signal (DMRS).

As an example, the first network device 110 may encode the essential control information including the second identifier and other control information, for example, an indication of frequency and/or time resources to be used by this subnetwork 205 for data communication. Noted that it may be assumed here that the synchronization channel is bundled with the synchronization signal.

In some example embodiments, the first network device 110 may then generate a reference signal associated with the synchronization channel based at least on the first identifier. For example, the first identifier may be set as an initial seed for the relevant sequence generation. As another example, the first identifier may be used to determine a base signal sequence. Furthermore, the first network device 110 may randomly selects a value from a pre-defined set, for example, {0,1,2,3}, which may determine a cyclic shift for the base sequence. Then, the reference signal may be determined as a function of not only the first identifier, but also the randomly selected value, which will benefit interference suppression over the reference signal and the synchronization channel.

In some example embodiments, the first network device 210 may transmit the synchronization signal and/or the synchronization channel to the terminal device 220 over time/frequency resources that are (pre)configured by the second network device 230 or pre-defined in the system specification.

Then, the respective terminal device 220 may detect the synchronization signal and/or channel to acquire the synchronization information and control information including the second identifier and other control information.

For example, the terminal device 220 may search or detect the synchronization signal to acquire the timing/frequency synchronization information of the subnetwork 205 and obtain the first identifier.

In the example embodiments where the first identifier is preconfigured between the first network device 210 and the terminal device 220, the terminal device 220 may persistently search and monitor the specific synchronization signal corresponding to the first identifier until a successful detection.

In some example embodiments where the first identifier is determined based on a set of first identifiers, the terminal device 220 may blindly search the candidate synchronization signal sequences corresponding to each candidate first identifier of the set of identifiers. For example, the terminal device 220 may start from the first identifier that has been used recently.

Further, in some example embodiments, the terminal device 220 may detect the synchronization channel to acquire the control information and parameters including the second identifier.

In the example embodiments where the reference signal associated with the synchronization channel is determined based on the first identifier, the terminal device 220 may determines the reference signal based on the first identifier. Then, the terminal device 220 may make channel estimation, and then decode the synchronization channel.

In the example embodiments where the reference signal associated with the synchronization channel is determined based on the first identifier as a base signal sequence and a randomly selected value from the pre-defined set for use as a cyclic shift, the terminal device 220 may firstly determines the base sequence based on the first identifier, then make hypothesis test for each cyclic shift corresponding to each selected value of the pre-defined set to perform channel estimation and/or synchronization channel decoding. On this basis, the terminal device 220 may obtain the control information and parameters including the second identifier. In this way, the low complexity and collision avoidance can be enabled and balanced well.

Further, in some example embodiments, the terminal device 220 may access the first network device 210 to establish the connections. The first network device 210 may make necessary configurations to the terminal device 220 to support the data communication within the subnetwork.

Then, as shown in FIG. 3, the first network device 210 uses (320) the second identifier in data communication, within the subnetwork 205, with the terminal device 220. For example, the first network device 210 may uses the second identifier to perform data communication with at least one of the plurality of terminal devices 220-1, 220-2, . . . , 220-N. Alternatively or in addition, a terminal device, such as the terminal device 220-1, of the plurality of terminal devices 220-1, 220-2, . . . , 220-N may use the second identifier of the subnetwork 205 in data communication with at least another terminal device of the plurality of terminal devices 220-1, 220-2, . . . , 220-N in the subnetwork 205, for example, the terminal device 220-2, or the terminal devices 220-2 to 220-4.

In some example embodiments, the first network device 210 may generate a sequence associated with a physical channel for the data communication based at least on the second identifier. Accordingly, the terminal device may obtain the sequence. For example, the physical channel may comprise a physical shared channel for data communication or a physical control channel for control information transmission for either downlink or uplink or sidelink within the subnetwork 205. As an example, the sequence may comprise a DMRS sequence.

In some example embodiments, the first network device 210 may generate a scrambling sequence associated with a scrambling operation for coded bits over the physical channel. For example, the scrambling sequence may be determined at least based on the second identifier.

As the first identifier is obtained from the detection of the synchronization signal, which is further used to detect the synchronization channel carrying at least the second identifier, to address the potential collisions of the first identifier due to its small length and the impact on detection of the synchronization channel, the first network device 210 may determine the sequence associated with a physical channel, such as a DMRS and/or the scrambling sequence of the synchronization channel based on the first identifier combined with some randomization, e.g., a randomly selected value from a pre-defined set as mentioned above. Accordingly, the terminal device 220 may make hypothesis tests to detect the synchronization channel and resolve the collisions. In this way, the low complexity and collision avoidance may be enabled and balanced well.

According to the proposed scheme, based on the use of the first identifier with a small length for synchronization signal generation, it allows a small search space for the terminal device 220 for determining the first identifier, which reduces complexity and power consumption for the terminal device 220. For example, for the first identifier with a length of 4 bits, the terminal device may search the synchronization signal and acquire the first identifier by trying at most 16 synchronization signal sequences, while if NR Physical cell ID (PCI) and associated synchronization signals are reused, the terminal device 220 may have to try for example 1008 synchronization signal sequences to obtain the PCI and synchronization which may be unaffordable for some subnetwork scenarios.

Further, based on the use of a second identifier with a large length which can be controlled and properly allocated or coordinated by the second network device 230 to avoid collisions among the proximate subnetworks. In this way, the potential inter-subnetwork interference can be suppressed.

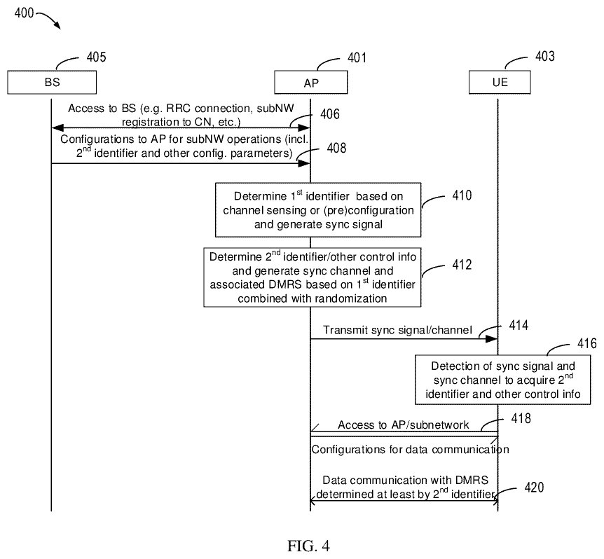

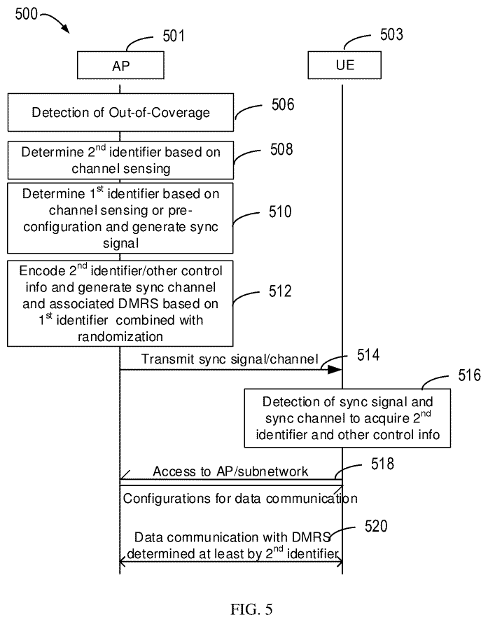

FIG. 4 shows an example process 400 with the proposed dual-identifier framework for a subnetwork in overlay network coverage according to some example embodiments of the present disclosure. For the purpose of discussion, the process 400 will be described with reference to FIG. 2. In this case, the first network device 210 is implemented by the AP 401, and the terminal device 220 is implemented by the UE 403, and the second network device 230 is implemented by the BS 405. In this case, the subnetwork is in the coverage of the BS 405 which can manage or coordinate the subnetworks in its coverage.

As shown in FIG. 4, at 406, the AP 401 accesses to the BS 405 on behalf of the whole subnetwork to perform necessary operations, for example, an establishment of RRC connections with the BS 405, registrations and authentications to the core network, and so on.

At 408, the BS 405 makes configurations of resource/parameter setting to the AP 401 to support the subnetwork operations. In particular, at least the second identifier or a set of second identifiers may be allocated by the BS 405 and included in the configurations.

At 410, the AP 401 determines the first identifier and generates a synchronization signal based on the first identifier. For example, the AP 401 may determine the first identifier in any suitable ways described with reference to FIG. 3.

At 412, the AP 401 determines the second identifier and other essential control information and then generates the synchronization channel and its associated reference signal, such as a DMRS signal. For example, the AP 401 may determine the second identifier in any suitable ways described with reference to FIG. 3. For example, the AP 401 may generate the associated reference signal in any suitable ways described with reference to FIG. 3, for example, based on the first identifier combined with randomization.

At 414, the AP 401 transmits the synchronization signal/channel to the terminal devices in the subnetwork, for example, including the UE 403. For example, the AP 401 may transmit the synchronization signal/channel over time/frequency resources that are (pre)configured by the overlay network or pre-defined in the system specification.

At 416, the UE 403 detects the synchronization signal/channel to acquire the synchronization information and control information including the second identifier and other control information. For example the UE 403 may search/detect the synchronization signal to acquire the timing/frequency synchronization information of the subnetwork and obtain the first identifier. For example, the UE 403 may obtain the first identifier value in any suitable ways described with reference to FIG. 3. Then, the UE 403 may detect the synchronization channel to acquire the control information and parameters including the second identifier. For example, the UE 403 may obtain the second identifier value in any suitable ways described with reference to FIG. 3. For example, the UE 403 may obtain the reference signal associated with the synchronization channel, such as the DMRS, in any suitable ways described with reference to FIG. 3.

Then, at 418, the UE 403 access the AP 401 to establish the connections and the AP 401 makes necessary configurations to the in-subnetwork devices to support the data communication within the subnetwork.

At 420, data communication is performed between the AP 401 and the UE 403. For example, the DMRS signal associated with the data communication may be generated at least based on the second identifier. As another example, a scrambling operation may be performed for the channel coded bits with the scrambling sequence generated based on the second identifier.

All operations and features as described above with reference to FIG. 3 are likewise applicable to the process 400 and have similar effects. For the purpose of simplification, the details will be omitted.

FIG. 5 shows another example process with the proposed dual-identifier framework for a subnetwork out of overlay network coverage according to some other example embodiments of the present disclosure. For the purpose of discussion, the process 500 will be described with reference to FIG. 2. In this case, the first network device 210 is implemented by the AP 501, and the terminal device 220 is implemented by the UE 503. In this case, the subnetwork is out of the coverage of a BS which can manage or coordinate the subnetworks in its coverage.

As shown in FIG. 5, at 506, the AP 501 detects that it is out of overlay network coverage, for example, the AP 501 may not acquire the synchronization signals from a BS of the overlay network for some time duration.

At 508, the AP 501 determines the second identifier based on channel sensing. For example, the AP 501 may try to detect the synchronization signal/channel from other subnetworks to identity which second identifiers are being used. Then the AP 501 may randomly select one second identifier from the available unused second identifiers.

At 510, the AP 501 determines the first identifier and based on that generate a synchronization signal. For example, the AP 501 may determine the first identifier based on channel sensing or pre-configuration.

At 512, the AP 501 encodes the second identifier and other control information to generate a synchronization channel and further generate associated DMRS based on the first identifier potentially combined with randomization, as described with reference to FIG. 3.

At 514, the AP 501 transmits the synchronization signal/channel to the terminal devices in the subnetwork, for example, including the UE 503. For example, the AP 501 may transmit the synchronization signal/channel over time/frequency resources that are (pre)configured by the overlay network or pre-defined in the system specification.

At 516, the UE 503 detects the synchronization signal/channel to acquire the synchronization information and control information including the second identifier and other control information. The specific operations are similar to the related operations as described in FIG. 4.

Then, at 518, the UE 503 accesses the AP 501 to establish the connections and the AP 501 makes necessary configurations to the in-subnetwork devices to support the data communication within the subnetwork.

At 520, data communication is performed between the AP 501 and the UE 503. For example, the DMRS signal associated with the data communication may be generated at least based on the second identifier. As another example, a scrambling operation may be performed for the channel coded bits with the scrambling sequence generated based on the second identifier.

All operations and features as described above with reference to FIG. 3 are likewise applicable to the process 500 and have similar effects. For the purpose of simplification, the details will be omitted.

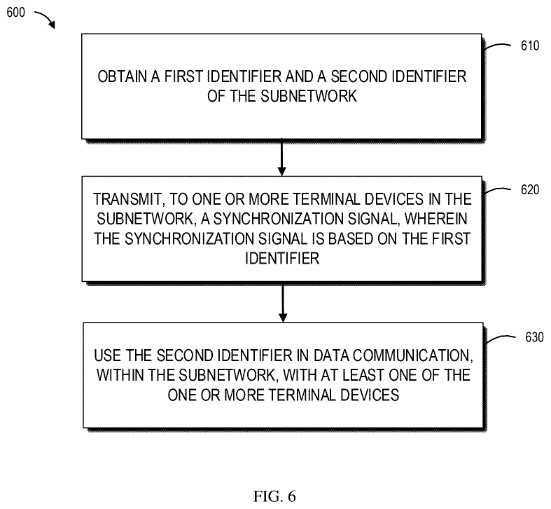

FIG. 6 shows a flowchart of an example method 600 according to some example embodiments of the present disclosure. The method 600 can be implemented at the first network device 210 as shown in FIG. 2. For the purpose of discussion, the method 600 will be described with reference to FIG. 2.

At block 610, the first network device 210 obtains a first identifier and a second identifier of the subnetwork. At block 620, the first network device 210 transmits, to one or more terminal devices 220 in the subnetwork 205, a synchronization signal, wherein the synchronization signal is based on the first identifier. At block 630, the first network device 210 uses the second identifier in data communication, within the subnetwork 205, with at least one of the one or more terminal devices 220.

In some example embodiments, the first network device 210 may transmit, to the one or more terminal devices 220 in the subnetwork 205, a message indicative of the second identifier.

In some example embodiments, the message may be transmitted via a synchronization channel in the subnetwork 205 with a reference signal associated with the synchronization channel.

In some example embodiments, the first network device 210 may generate the reference signal associated with the synchronization channel based at least on the first identifier.

In some example embodiments, the reference signal may be a demodulation reference signal, DMRS.

In some example embodiments, the first network device 210 may receive, from a second network device 230 in the radio access network, configuration information indicative of at least one second identifier; and obtain the second identifier based at least on the at least one second identifier.

In some example embodiments, the configuration information further may comprise at least one first identifier.

In some example embodiments, the first network device 210 may obtain the first identifier from at least one first identifier or based on a preconfigured value.

In some example embodiments, the first network device 210 may generate a sequence associated with a physical channel for the data communication based at least on the second identifier.

In some example embodiments, the sequence may be a demodulation reference signal, DMRS, sequence.

In some example embodiments, the first network device 210 may comprise an access point and the second network device 230 may comprise a base station.

Those skilled in the art can understand that all operations and features as described above with reference to FIGS. 3-5 are likewise applicable to the method 600 and have similar effects.

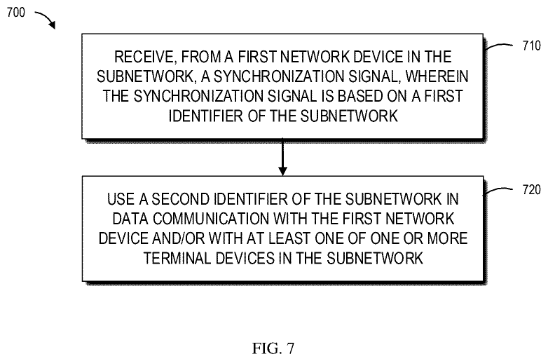

FIG. 7 shows a flowchart of an example method 700 according to some example embodiments of the present disclosure. The method 700 can be implemented at the terminal device 220 as shown in FIG. 2. For the purpose of discussion, the method 700 will be described with reference to FIG. 2.

At block 710, the terminal device 220 receives, from a first network device 210 in the subnetwork 205, a synchronization signal, wherein the synchronization signal is based on a first identifier of the subnetwork 205. At block 720, the terminal device 220 uses a second identifier of the subnetwork 205 in data communication with the first network device 210 and/or with at least one of one or more terminal devices in the subnetwork 205.

In some example embodiments, the terminal network 220 may receive, from the first network device 210, a message indicative of the second identifier.

In some example embodiments, the message may be transmitted via a synchronization channel in the subnetwork 205 with a reference signal associated with the synchronization channel.

In some example embodiments, the terminal device 220 may obtain the reference signal associated with the synchronization channel based at least on the first identifier.

In some example embodiments, the reference signal may be a demodulation reference signal, DMRS.

In some example embodiments, the terminal device 220 may obtain a sequence associated a physical channel for the data communication in the subnetwork 205 based at least on the second identifier.

In some example embodiments, the sequence may be a demodulation reference signal, DMRS, sequence.

In some example embodiments, the first network device 210 may comprise an access point.

Those skilled in the art can understand that all operations and features as described above with reference to FIGS. 3-5 are likewise applicable to the method 700 and have similar effects.

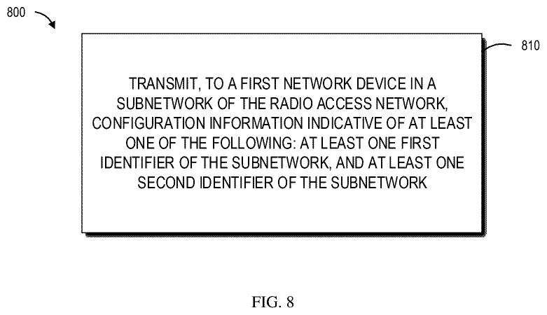

FIG. 8 shows a flowchart of an example method 800 according to some example embodiments of the present disclosure. The method 800 can be implemented at the second network device 230 as shown in FIG. 2. For the purpose of discussion, the method 800 will be described with reference to FIG. 2.

At block 810, the second network device 230 transmits, to the first network device 210 in the subnetwork 205 of the radio access network, configuration information indicative of at least one of the following: at least one first identifier of the subnetwork 205, and at least one second identifier of the subnetwork 205.

In some example embodiments, the first network device 210 may comprise an access point and the second network device 230 may comprise a base station.

Those skilled in the art can understand that all operations and features as described above with reference to FIGS. 3-5 are likewise applicable to the method 800 and have similar effects.

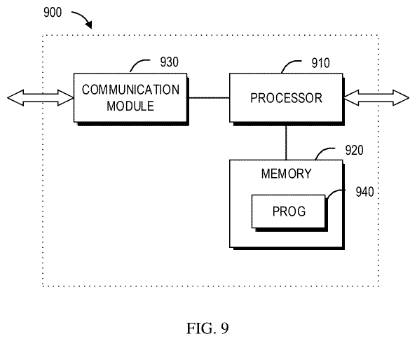

FIG. 9 is a simplified block diagram of a device 900 that is suitable for implementing example embodiments of the present disclosure. The device 900 can be implemented at or as a part of the first network device 210, or the terminal device 220, or the second network device 230 as shown in FIG. 1.

As shown, the device 900 includes a processor 910, a memory 920 coupled to the processor 910, a communication module 930 coupled to the processor 910, and a communication interface (not shown) coupled to the communication module 930. The memory 920 stores at least a program 940. The communication module 930 is for bidirectional communication, for example, via multiple antennas. The communication interface may represent any interface that is necessary for communication.

The program 940 is assumed to include program instructions that, when executed by the associated processor 910, enable the device 900 to operate in accordance with the example embodiments of the present disclosure, as discussed herein with reference to FIGS. 2-8. The example embodiments herein may be implemented by computer software executable by the processor 910 of the device 900, or by hardware, or by a combination of software and hardware. The processor 910 may be configured to implement various example embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

When the device 900 acts as the first network device 210 or a part of the first network device 210, the processor 910 and the communication module 930 may cooperate to implement the method 600 as described above with reference to FIG. 6. When the device 900 acts as the terminal device 220 or a part of the terminal device 220, the processor 910 and the communication module 930 may cooperate to implement the method 700 as described above with reference to FIG. 7. When the device 900 acts as the second network device 230 or a part of the second network device 230, the processor 910 and the communication module 930 may cooperate to implement the method 800 as described above with reference to FIG. 8. All operations and features as described above with reference to FIGS. 2-8 are likewise applicable to the device 900 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 or 700 or 800 as described above with reference to FIGS. 6-8. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a first network device in a subnetwork of a radio access network comprises: at least one processor; and at least one memory including computer program code; the at least one memory and the computer program code configured to, with the at least one processor, cause the first network device to: obtain a first identifier and a second identifier of the subnetwork; transmit, to one or more terminal devices in the subnetwork, a synchronization signal, wherein the synchronization signal is based on the first identifier; and use the second identifier in data communication, within the subnetwork, with at least one of the one or more terminal devices.

In some example embodiments, the first network device is further caused to: transmit, to the one or more terminal devices in the subnetwork, a message indicative of the second identifier.

In some example embodiments, the message is transmitted via a synchronization channel in the subnetwork with a reference signal associated with the synchronization channel.

In some example embodiments, the first network device is further caused to: generate the reference signal associated with the synchronization channel based at least on the first identifier.

In some example embodiments, the reference signal is a demodulation reference signal, DMRS.

In some example embodiments, the first network device is further caused to: receive, from a second network device in the radio access network, configuration information indicative of at least one second identifier; and obtain the second identifier based at least on the at least one second identifier.

In some example embodiments, the configuration information further comprises at least one first identifier.

In some example embodiments, the first network device is further caused to: obtain the first identifier from at least one first identifier or based on a preconfigured value.

In some example embodiments, the first network device is further caused to: generate a sequence associated with a physical channel for the data communication based at least on the second identifier.

In some example embodiments, the sequence is a demodulation reference signal, DMRS, sequence.

In some example embodiments, the first network device in a subnetwork of a radio access network comprises an access point and the second network device comprises a base station.

In some aspects, a terminal device in a subnetwork of a radio access network comprises: at least one processor; and at least one memory including computer program code; the at least one memory and the computer program code configured to, with the at least one processor, cause the terminal device to: receive, from a first network device in the subnetwork, a synchronization signal, wherein the synchronization signal is based on a first identifier of the subnetwork; and use a second identifier of the subnetwork in data communication with the first network device and/or with at least one of one or more terminal devices in the subnetwork.

In some example embodiments, the terminal device is further caused to: receive, from the first network device, a message indicative of the second identifier.

In some example embodiments, the message is transmitted via a synchronization channel in the subnetwork with a reference signal associated with the synchronization channel.

In some example embodiments, the terminal device is further caused to: obtain the reference signal associated with the synchronization channel based at least on the first identifier.

In some example embodiments, the reference signal is a demodulation reference signal, DMRS.

In some example embodiments, the terminal device is further caused to: obtain a sequence associated a physical channel for the data communication in the subnetwork based at least on the second identifier.

In some example embodiments, the sequence is a demodulation reference signal, DMRS, sequence.

In some example embodiments, the first network device comprises an access point.

In some aspects, a second network device in a radio access network comprises: at least one processor; and at least one memory including computer program code; the at least one memory and the computer program code configured to, with the at least one processor, cause the second network device to: transmit, to a first network device in a subnetwork of the radio access network, configuration information indicative of at least one of the following: at least one first identifier of the subnetwork, and at least one second identifier of the subnetwork.

In some example embodiments, the first network device comprises an access point and the second network device comprises a base station.

In some aspects, a method comprises: at a first network device in a subnetwork of a radio access network, obtaining a first identifier and a second identifier of the subnetwork; transmitting, to one or more terminal devices in the subnetwork, a synchronization signal, wherein the synchronization signal is based on the first identifier; and using the second identifier in data communication, within the subnetwork, with at least one of the one or more terminal devices.

In some example embodiments, the method further comprises: transmitting, to the one or more terminal devices in the subnetwork, a message indicative of the second identifier.

In some example embodiments, the message is transmitted via a synchronization channel in the subnetwork with a reference signal associated with the synchronization channel.

In some example embodiments, the method further comprises: generating the reference signal associated with the synchronization channel based at least on the first identifier.

In some example embodiments, the reference signal is a demodulation reference signal, DMRS.

In some example embodiments, the method further comprises: receiving, from a second network device in the radio access network, configuration information indicative of at least one second identifier; and obtaining the second identifier based at least on the at least one second identifier.

In some example embodiments, the configuration information further comprises at least one first identifier.

In some example embodiments, the method further comprises: obtaining the first identifier from at least one first identifier or based on a preconfigured value.

In some example embodiments, the method further comprises: generating a sequence associated with a physical channel for the data communication based at least on the second identifier.

In some example embodiments, the sequence is a demodulation reference signal, DMRS, sequence.

In some example embodiments, the first network device comprises an access point and the second network device comprises a base station.

In some aspects, a method comprises: at a terminal device in a subnetwork of a radio access network, receiving, from a first network device in the subnetwork, a synchronization signal, wherein the synchronization signal is based on a first identifier of the subnetwork; and using a second identifier of the subnetwork in data communication with the first network device and/or with at least one of one or more terminal devices in the subnetwork.

In some example embodiments, the method further comprises: receiving, from the first network device, a message indicative of the second identifier.

In some example embodiments, the message is transmitted via a synchronization channel in the subnetwork with a reference signal associated with the synchronization channel.

In some example embodiments, the method further comprises: obtaining the reference signal associated with the synchronization channel based at least on the first identifier.

In some example embodiments, the reference signal is a demodulation reference signal, DMRS.

In some example embodiments, the method further comprises: obtaining a sequence associated a physical channel for the data communication in the subnetwork based at least on the second identifier.

In some example embodiments, the sequence is a demodulation reference signal, DMRS, sequence.

In some example embodiments, the first network device comprises an access point.

In some aspects, a method comprises: at a second network device in a radio access network, transmitting, to a first network device in a subnetwork of the radio access network, configuration information indicative of at least one of the following: at least one first identifier of the subnetwork, and at least one second identifier of the subnetwork.

In some example embodiments, the first network device comprises an access point and the second network device comprises a base station.

In some aspects, an apparatus implemented at a first network device in a subnetwork of a radio access network comprises: means for obtaining a first identifier and a second identifier of the subnetwork; means for transmitting, to one or more terminal devices in the subnetwork, a synchronization signal, wherein the synchronization signal is based on the first identifier; and means for using the second identifier in data communication, within the subnetwork, with at least one of the one or more terminal devices.

In some example embodiments, the apparatus further comprises: means for transmitting, to the one or more terminal devices in the subnetwork, a message indicative of the second identifier.

In some example embodiments, the message is transmitted via a synchronization channel in the subnetwork with a reference signal associated with the synchronization channel.

In some example embodiments, the apparatus further comprises: means for generating the reference signal associated with the synchronization channel based at least on the first identifier.

In some example embodiments, the reference signal is a demodulation reference signal, DMRS.

In some example embodiments, the apparatus further comprises: means for receiving, from a second network device in the radio access network, configuration information indicative of at least one second identifier; and obtaining the second identifier based at least on the at least one second identifier.

In some example embodiments, the configuration information further comprises at least one first identifier.

In some example embodiments, the apparatus further comprises: means for obtaining the first identifier from at least one first identifier or based on a preconfigured value.

In some example embodiments, the apparatus further comprises: means for generating a sequence associated with a physical channel for the data communication based at least on the second identifier.

In some example embodiments, the sequence is a demodulation reference signal, DMRS, sequence.

In some example embodiments, the first network device comprises an access point and the second network device comprises a base station.

In some aspects, an apparatus implemented at a terminal device in a subnetwork of a radio access network comprises: means for receiving, from a first network device in the subnetwork, a synchronization signal, wherein the synchronization signal is based on a first identifier of the subnetwork; and means for using a second identifier of the subnetwork in data communication with the first network device and/or with at least one of one or more terminal devices in the subnetwork.

In some example embodiments, the apparatus further comprises: means for receiving, from the first network device, a message indicative of the second identifier.

In some example embodiments, the message is transmitted via a synchronization channel in the subnetwork with a reference signal associated with the synchronization channel.

In some example embodiments, the apparatus further comprises: means for obtaining the reference signal associated with the synchronization channel based at least on the first identifier.

In some example embodiments, the reference signal is a demodulation reference signal, DMRS.

In some example embodiments, the apparatus further comprises: means for obtaining a sequence associated a physical channel for the data communication in the subnetwork based at least on the second identifier.

In some example embodiments, the sequence is a demodulation reference signal, DMRS, sequence.

In some example embodiments, the first network device comprises an access point.

In some aspects, an apparatus implemented at a second network device in a radio access network comprises: means for transmitting, to a first network device in a subnetwork of the radio access network, configuration information indicative of at least one of the following: at least one first identifier of the subnetwork, and at least one second identifier of the subnetwork.

In some example embodiments, the first network device comprises an access point and the second network device comprises a base station.

In some aspects, a computer readable storage medium comprises program instructions stored thereon, the instructions, when executed by a processor of a device, causing the device to perform the method according to some example embodiments of the present disclosure.

1.-28. (canceled)

29. A terminal device in a subnetwork of a radio access network, the terminal device comprising:
at least one processor; and
at least one memory including computer program code that, when executed by the at least one processor, cause the terminal device to:
detect a synchronization channel associated with a first network device in the subnetwork, wherein the synchronization channel is based on a first identifier of the subnetwork, the first identifier having a length of four bits;
receive, from the first network device, a message transmitted via the synchronization channel in the subnetwork with a reference signal associated with the synchronization channel, the message being indicative of a second identifier, and wherein the reference signal is a demodulation reference signal (DMRS);
obtain the reference signal associated with the synchronization channel, the reference signal being based at least on the first identifier as a base signal sequence and a randomly selected value from a pre-defined set for use as a cyclic shift;
determine a base sequence based on the first identifier;
make a hypothesis test for each cyclic shift corresponding to each selected value of the pre-defined set;
based on the hypothesis test for cyclic shift, perform channel estimation and synchronization channel decoding;
based on performing the channel estimation and the synchronization channel decoding, acquire, from the synchronization channel, synchronization information and control information including the second identifier, the second identifier having a length of ten bits; and
use the second identifier of the subnetwork in data communication with the first network device and with at least one of one or more terminal devices in the subnetwork.

30. The terminal device of claim 29, wherein the reference signal is generated by the first network device based at least on the first identifier.

31. The terminal device of claim 30, wherein the first identifier is set as an initial seed for relevant sequence generation when generating the reference signal.

32. The terminal device of claim 31, wherein the first identifier is determined from configuration information of the subnetwork and by excluding other first identifiers being used by other proximate subnetworks.

33. The terminal device of claim 32, wherein the second identifier is determined from the configuration information of the subnetwork and by excluding other second identifiers being used by other proximate subnetworks.

34. The terminal device of claim 33, wherein the computer program code when executed by the least one processor, further causes the terminal device to perform the following operations:
obtaining a sequence associated a physical channel for data communication in the subnetwork based at least on the second identifier, wherein the sequence is a DMRS sequence.

35. The terminal device of claim 34, wherein the first network device comprises an access point.

36. A system comprising:
a terminal device in a subnetwork of a radio access network;
at least one processor; and
at least one memory including computer program code that, when executed by the at least one processor, cause the terminal device to:
detect a synchronization channel associated with a first network device in the subnetwork, wherein the synchronization channel is based on a first identifier of the subnetwork, the first identifier having a length of four bits;
receive, from the first network device, a message transmitted via the synchronization channel in the subnetwork with a reference signal associated with the synchronization channel, the message being indicative of a second identifier, and wherein the reference signal is a demodulation reference signal (DMRS);
obtain the reference signal associated with the synchronization channel, the reference signal being based at least on the first identifier as a base signal sequence and a randomly selected value from a pre-defined set for use as a cyclic shift;
determine a base sequence based on the first identifier;
make a hypothesis test for each cyclic shift corresponding to each selected value of the pre-defined set;
based on the hypothesis test for cyclic shift, perform channel estimation and synchronization channel decoding;
based on performing the channel estimation and the synchronization channel decoding, acquire, from the synchronization channel, synchronization information and control information including the second identifier, the second identifier having a length of ten bits; and
use the second identifier of the subnetwork in data communication with the first network device and with at least one of one or more terminal devices in the subnetwork.

37. The terminal device of claim 36, wherein the reference signal is generated by the first network device based at least on the first identifier.

38. The terminal device of claim 37, wherein the first identifier is set as an initial seed for relevant sequence generation when generating the reference signal.

39. The terminal device of claim 38, wherein the first identifier is determined from configuration information of the subnetwork and by excluding other first identifiers being used by other proximate subnetworks.

40. The terminal device of claim 39, wherein the second identifier is determined from the configuration information of the subnetwork and by excluding other second identifiers being used by other proximate subnetworks.

41. The terminal device of claim 40, wherein the computer program code when executed by the least one processor, further causes the terminal device to perform the following operations:
obtaining a sequence associated a physical channel for data communication in the subnetwork based at least on the second identifier, wherein the sequence is a DMRS sequence.

42. The terminal device of claim 41, wherein the first network device comprises an access point.

43. A method comprising:
detecting a synchronization channel associated with a first network device, wherein the synchronization channel is based on a first identifier of the subnetwork, the first identifier having a length of four bits;
receiving, from the first network device, a message transmitted via the synchronization channel in the subnetwork with a reference signal associated with the synchronization channel, the message being indicative of a second identifier, and wherein the reference signal is a demodulation reference signal (DMRS);
obtaining the reference signal associated with the synchronization channel, the reference signal being based at least on the first identifier as a base signal sequence and a randomly selected value from a pre-defined set for use as a cyclic shift;
determining a base sequence based on the first identifier;
making a hypothesis test for each cyclic shift corresponding to each selected value of the pre-defined set;
based on the hypothesis test for cyclic shift, performing channel estimation and synchronization channel decoding;
based on performing the channel estimation and the synchronization channel decoding, acquiring, from the synchronization channel, synchronization information and control information including the second identifier, the second identifier having a length of ten bits; and
using the second identifier of the subnetwork in data communication with the first network device and with at least one of one or more terminal devices in the subnetwork.

44. The method of claim 36, wherein the reference signal is generated by the first network device based at least on the first identifier.

45. The method of claim 37, wherein the first identifier is set as an initial seed for relevant sequence generation when generating the reference signal.

46. The method of claim 38, wherein the first identifier is determined from configuration information of the subnetwork and by excluding other first identifiers being used by other proximate subnetworks.

47. The method of claim 39, wherein the second identifier is determined from the configuration information of the subnetwork and by excluding other second identifiers being used by other proximate subnetworks.

48. The method of claim 40, further comprising:
obtaining a sequence associated a physical channel for data communication in the subnetwork based at least on the second identifier, wherein the sequence is a DMRS sequence
